(19) United States
(12) Patent Application Publication
(10) Pub. No.: US 2011/0099394 A1
(43) Pub. Date: Apr. 28, 2011

(54) POWER MANAGEMENT IN A DATA PROCESSING APPARATUS

(75) Inventor: Joe N. Brown, Austin, TX (US)

(73) Assignee: International Business Machines Corporation, Armonk, NY (US)

(21) Appl. No.: 12/604,158

(22) Filed: Oct. 22, 2009

(51) Int. Cl. G06F 1/00

(52) U.S. Cl. 713/310

(57) ABSTRACT

In a data processing apparatus, a power mode is selected based on data regarding an operating status of a power utility powering the apparatus. The data is transmitted via power supply lines and includes information on timing/duration of present or anticipated brown-out and/or black-out conditions of the power utility. Power management functions can be performed, for example, using a BIOS of the apparatus or a power management application program.

### BACKGROUND OF THE INVENTION

1. Technical Field

The present invention generally relates to data processing systems and, in particular, to techniques for providing power management in a data processing apparatus.

2. Description of the Related Art

The proper operation of many data processing systems is dependent upon a continuous supply of uninterrupted AC power within a given tolerance of a specified voltage and frequency. If a power interruption or a variance in power delivery outside of the tolerance occurs, the data processing system may lose essential state information, leading to computational error, or may enter a state requiring system reset or reboot.

Conventionally, system administrators and users of data processing systems are unaware of current or imminent operating conditions at power utilities providing AC power to such equipment. Consequently, brown-out and black-out conditions at the power utilities, unless they are timely mitigated, may cause performance degradation and malfunctioning of the data processing equipment.

### SUMMARY OF ILLUSTRATIVE EMBODIMENTS

A method, apparatus, and computer program product for providing power management in data processing equipment are disclosed.

In one embodiment, a power mode of a data processing apparatus is selected based on data regarding an operating status of a power utility powering the apparatus. The data is transmitted via power supply lines and includes information on timing/duration of present or anticipated brown-out and/or black-out conditions of the power utility. Power management functions can be performed, for example, using a BIOS of the apparatus or a power management application program.

All objects, features and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high-level block diagram of a data processing apparatus configured for implementing one or more embodiments of the invention.

FIG. 2 is a high-level block diagram of an alternative data processing apparatus in accordance with one or more embodiments.

FIG. 3 is a high-level logical flowchart of an exemplary method of power control in accordance with one embodiment.

The images in the drawings are simplified for illustrative purposes and are not depicted to scale. To facilitate understanding, identical reference numerals are used, where possible, to designate substantially identical elements that are common to the figures, except that suffixes may be added, when appropriate, to differentiate such elements.

It has been contemplated that features of one embodiment may be incorporated in other embodiments of the invention without further recitation.

### DETAILED DESCRIPTION OF AN ILLUSTRATIVE EMBODIMENT

The present invention provides a method, apparatus, and computer program product for providing power management in data processing equipment. The invention may advantageously be utilized, for example, in high performance data processing systems and apparatuses, such as Blue Gene™ and Deep Purple™ systems and eServers™ of IBM Corporation of Armonk, N.Y.

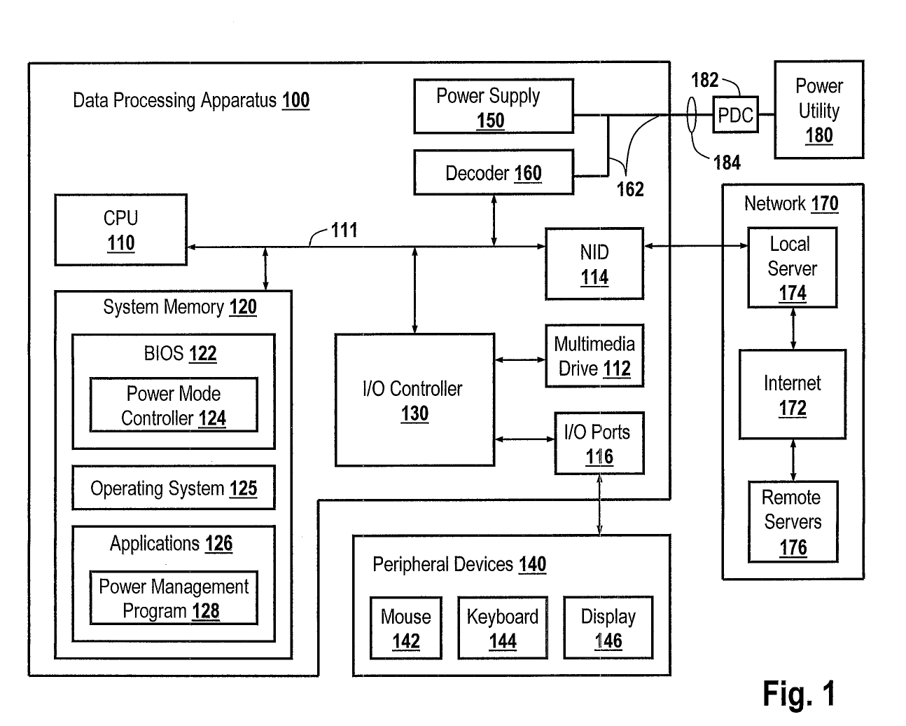

With reference now to the figures, and in particular with reference to FIG. 1, there is illustrated a high-level block diagram of an illustrative embodiment of data processing apparatus (DPA) 100 configured for implementing one or more embodiments of the invention. In operation, DPA 100 is coupled to peripheral devices 140 and network 170 and powered by power utility 180.

In one embodiment, DPA 100 generally comprises at least one central processing unit (CPU) 110, system memory 120, input/output (I/O) controller 130, multimedia drive 112, network interface device (NID) 114 (for example, a modem or network interface card), a plurality of I/O ports 116, an AC power supply 150, a decoder 160 of data transmitted over power supply lines 184, and a system bus 111. Examples of DPAs 100 include computers, workstations, and servers, among other AC-powered data processing apparatuses.

System memory 120 may include, among other data storage elements, hard/optical drives, firmware memory devices, cache memory, random access memory (RAM), and read only memory (ROM). Illustrated system memory 120 comprises a number of software/firmware components, including Basic Input/Output System (BIOS) 122, operating system (OS) 125, and applications 126. OS 125 (e.g., Microsoft Windows®, Unix®, GNU®/Linux®, or AIX®) supports execution and user interface features of applications 126. In alternate embodiments, at least portions of OS 125 and/or applications 126 may reside on multimedia drive 112 or devices communicatively connected to NID 114 or I/O ports 116.

I/O controller 130 provides connectivity and control functions for various input and output devices connected to or incorporated into DPA 100, such as shown herein exemplary multimedia drive 112, I/O ports 114, mouse 142, keyboard 144, and display 146.

Network 170 is generally a collection of local and wide area networks and gateways (e.g., servers), which may utilize, for example, Transmission Control and Internet Protocols (TCP/IP) to communicate with one another (illustratively, the Internet 172 and local and remote servers 174, 176 are shown) and various computerized devices (not shown).

Power utility 180 is generally an electric utility that is powering DPA 100 via, for example, one or more power distribution centers (PDC) 182, such as power sub-stations, transformers, switchboards, and the like. It should be appreciated that PDC(s) 182 may be collocated with or downstream from power utility 180. In the present invention, output AC voltage of power utility 180 is modulated with a sub-carrier signal, which is encoded with data on an operating status of the power utility. The data is transmitted to DPA 100 via power supply lines 184 connected to AC power wiring 162 of the DPA.

Such data transmissions may be performed using Power Line Communication (PLC) protocols, for example, PLC protocols developed by the Home Power Line Alliance, Universal Powerline Association, European Telecommunications Standards Institute, or IEEE. In one particular embodiment, the transmitted data includes information on timing/duration of present or anticipated/imminent brown-out and/or black-out conditions at power utility 180.

In the depicted embodiment, the data transmissions are received and decoded using decoder 160 (e.g., power-line modem), which data input is coupled, for example, capacitively, inductively, or galvanically to AC power wiring 162. In alternate embodiments (not shown), decoder 160 may be a portion of AC power supply 150 or a stand-alone device coupled to DPA 100 via, for example, NID 114 or one of I/O ports 116. Via system bus 111, the decoded data may be accessed by CPU 110, BIOS 122, and applications 126.

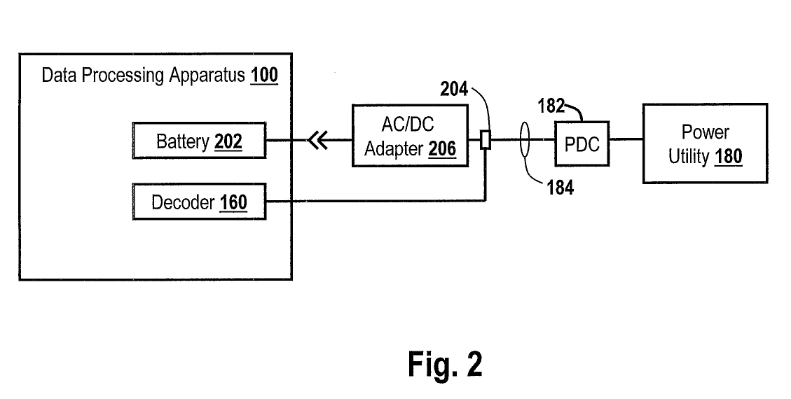

Referring now to FIG. 2, in an alternative embodiment, a DPA 100, such as, e.g., laptop computer, may be powered by AC power or electric battery 202. In this embodiment, the data input of decoder 160 is coupled to any AC outlet powered by power utility 180. For example, the data input of decoder 160 may be coupled, to AC outlet 204 used by a charger (i.e., AC/DC adapter) 206 of battery 202.

In DPA 100, power management functions are executed by power mode controller 124 or, alternatively or additionally, power management program 128. In the depicted embodiment, power mode controller 124 and power management program 128 are portions of BIOS 122 and applications 126, respectively. In alternate embodiments, power mode controller 124 may be a hardware device, a firmware module, a software module, or any combination thereof, and at least portions of power management program 128 may reside on a remote memory device (e.g., within local server 174 or remote servers 176) communicatively coupled to DPA 100.

In operation, information on operating conditions at power utility 180, which is contained in the data transmitted via AC power lines 184, is decoded by decoder 160 and thereafter provided to BIOS 122 and/or power management program 128. In one embodiment, power mode controller 124 and/or power management program 128 are pre-configured (e.g., by a user of DPA 100 or a system administrator of a network including or coupled to DPA 100) for executing one or more power saving modes in DPA 100. In the power saving modes, at least portions of internal components of DPA 100 or peripheral devices 140 may be partially powered off (for example, display 146) or disconnected, and some applications 126 or portions thereof may be prevented from starting or gracefully exited. In further embodiments, DPA 100 may also transmit (e.g., via NID 114), the decoded data and/or corresponding settings for power mode controller 124 or power management program 128 to computerized systems and other DPAs communicatively coupled to DPA 100.

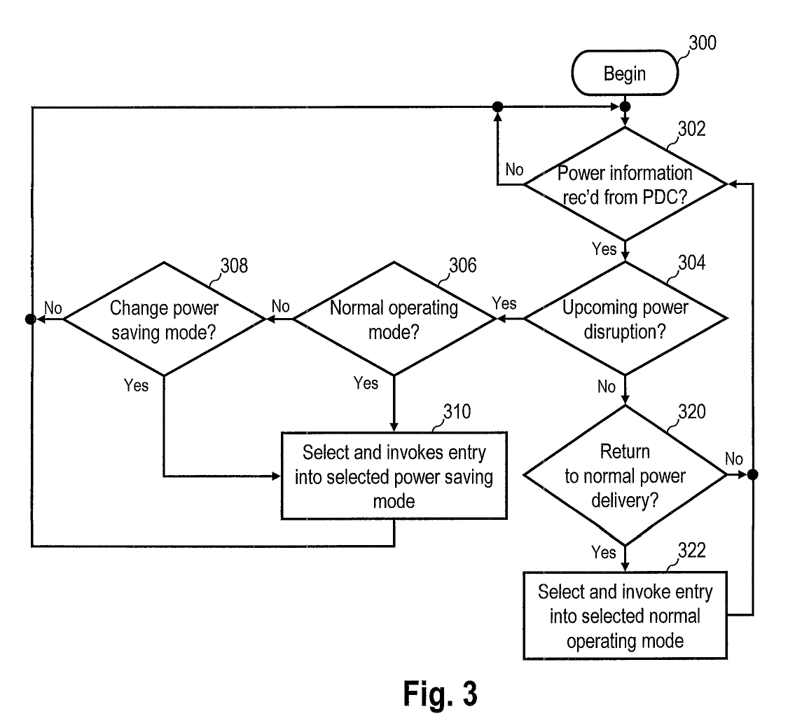

With reference now to FIG. 3, there is illustrated a high-level logical flowchart of an exemplary method of power control in accordance with one embodiment. The illustrated process begins at block 300 and then proceeds to block 302, which illustrates power mode controller 124 and/or power management program 128 determining whether or not power information has been received from a PDC 182. If not, the process iterates at block 302 until power information is received.

In response to a determination at block 302 that power information has been received, power mode controller 124 and/or power management program 128 further determines at block 304 whether or not the power information indicates an upcoming power disruption, such as a black-out or brown-out. If not, the process proceeds to block 320, which is described below. However, if a determination is made at block 304 that the power information received from PDC 182 indicates an upcoming power disruption, the process passes to block 306.

Block 306 depicts power mode controller 124 and/or power management program 128 determining whether DPA 100 is operating in a normal operating mode, for example, a high performance mode associated with the provision of normal AC power. If so, power mode controller 124 and/or power management program 128 selects a power saving mode to mitigate the anticipated negative effect(s) of the upcoming power disruption and invokes entry of DPA 100 into the selected power saving mode, preferably in advance of the power disruption. As noted above, in the power saving mode(s), at least portions of internal components of DPA 100 or peripheral devices 140 may be partially powered off (for example, display 146) or disconnected, and/or some applications 126 or portions thereof may be prevented from starting, may be placed in a stable state, or gracefully exited. Following block 310, the process returns to block 302.

Referring again to block 306, in response to a determination that DPA 100 is not in a normal operating mode, but is instead in a power saving mode, power mode controller 124 and/or power management program 128 determines whether to change the power saving mode, for example, to a power saving mode characterized by lower power consumption. If not, the process returns to block 302. However, if a determination is made at block 308 to change the power saving mode, the process proceeds to block 310 and then to block 302, which have been described.

Referring now to block 320, power mode controller 124 and/or power management program 128 determines whether or not the power information received from PDC 182 indicates an upcoming return to normal power delivery. If not, the process returns to block 302, which has been described. If, however, a determination is made at block 320 that the power information received from PDC 182 indicates an upcoming return to normal power delivery, power mode controller 124 and/or power management program 128 selects a normal operating mode (if more than one such mode is available) and invokes entry into the normal operating mode, for example, by providing or increasing power to peripheral devices, invoking or resuming applications 126, etc. Thereafter, the process returns to block 302, which has been described.

While the invention has been particularly shown as described with reference to a preferred embodiment, it will be understood by those skilled in the art that various changes in form and detail may be made therein without departing from the spirit and scope of the invention. For example, those of ordinary skill in the art will appreciate that hardware and software configurations depicted in FIGS. 1 and 2 may vary and that other hardware and/or software components may be used in DPA 100 in addition to or in place of the depicted components. In particular, in some embodiments, the controller of the power modes of DPA 100 may be implemented as an Operating System Power Management (OSPM) component of OS 125. In such embodiments, the OSPM component can employ low level routines of the Advanced Configuration and Power Interface (ACPI) to perform power management of DPA 100.

Furthermore, although aspects of the present invention have been described with respect to a data processing system executing software that directs the functions of the present invention, it should be understood that present invention may alternatively be implemented as a program product including program code stored within a computer readable storage medium. Program code defining the functions of the present invention can be delivered via a variety of computer readable media, which include, without limitation, non-rewritable storage media (e.g., CD-ROM), rewritable storage media (e.g., a floppy diskette, flash memory, or hard disk drive). It should be understood, therefore, that such computer readable storage media, when carrying or encoding computer readable instructions that direct the functions of the present invention, represent alternative embodiments of the present invention.

What is claimed is:

1. A data processing apparatus, comprising:
a processor;
data storage coupled to the processor;
a decoder of data transmitted via power supply lines of the apparatus; and
a controller coupled to the decoder that, responsive to the data, changes power modes of the data processing apparatus.

2. The data processing apparatus of claim 1, wherein the data indicates a power disruption at a power utility powering the data processing apparatus.

3. The data processing apparatus of claim 1, and further comprising a power supply of the data processing apparatus, wherein the decoder is a portion of the power supply.

4. The data processing apparatus of claim 1, wherein the controller comprises a hardware device.

5. The data processing apparatus of claim 1, wherein the controller is a portion of a Basic Input/Output System (BIOS) of the data processing apparatus.

6. The data processing apparatus of claim 1, wherein the controller comprises an application program executable by the data processing apparatus.

7. The data processing apparatus of claim 1, wherein the data processing apparatus comprises a computer.

8. A method of selecting a power mode of a data processing apparatus, the method comprising:
receiving, via power supply lines connecting the data processing apparatus to a power utility, data indicating an operating status of the power utility; and
in response to receiving the data, the data processing apparatus selecting a particular power mode among a plurality of power modes of the data processing apparatus based on the operating status of the power utility; and
invoking entry into the particular power mode.

9. The method of claim 8, wherein the data indicates a power disruption at the power utility powering the data processing apparatus.

10. The method of claim 8, further comprising:
decoding the received data; and
transmitting the decoded data via a system bus of the data processing apparatus.

11. The method of claim 8, wherein said selecting step includes a Basic Input/Output System (BIOS) of the data processing apparatus selecting the particular power mode.

12. The method of claim 8, further comprising:
transmitting the data to at least one data processing system communicatively coupled to the data processing apparatus.

13. A program product, comprising:
computer readable storage medium; and
program code stored within the computer readable storage medium, wherein the program code when processed by a data processing apparatus causes the data processing apparatus to perform a process including:
receiving, via power supply lines connecting the data processing apparatus to a power utility, data indicating an operating status of the power utility; and
in response to receiving the data, the data processing apparatus selecting a particular power mode among a plurality of power modes of the data processing apparatus based on the operating status of the power utility; and
invoking entry into the particular power mode.

14. The program product of claim 13, wherein the data indicates a power disruption at the power utility powering the data processing apparatus.

15. The program product of claim 13, wherein the process further includes:
decoding the received data; and
transmitting the decoded data via a system bus of the data processing apparatus.

16. The program product of claim 13, wherein said selecting includes a Basic Input/Output System (BIOS) of the data processing apparatus selecting the particular power mode.

17. The program product of claim 13, wherein the process further includes:
transmitting the data to at least one data processing system communicatively coupled to the data processing apparatus.
